(19) United States
(12) Patent Application Publication
(10) Pub. No.: US 2003/0118690 A1
(43) Pub. Date: Jun. 26, 2003

(54) High-fat animal feed tub

(76) Inventors: Steven J. Bartle, Quincy, IL (US); Basil D. Bevans, Quincy, IL (US); Dan S. Hickman, Payson, IL (US); Bruce W. Moechnig, Quincy, IL (US)

Correspondence Address: Michael E. Yates, Archer-Daniels-Midland Company, 4666 East Faries Parkway, Decatur, IL, 62526, US

(21) Appl. No.: 10/025,757

(22) Filed: Dec. 21, 2001

(51) Int. Cl. A01K 1/00

(52) U.S. Cl. 426/2

(57) ABSTRACT

A high fat animal feed tub is provided. Higher fat levels are achieved through the use of a low moisture, high fat ingredient in the formulation of the high fat animal feed tub of the invention. The process for producing such tubs is also provided. Use of such tubs provides a high energy feed source for animals, especially beef and dairy cattle.

### FIELD OF THE INVENTION

This invention relates to animal feed products. More specifically, the present invention relates to high fat content high-energy source animal feed tubs, and the methods for their production.

### BACKGROUND

The animal feed industry is currently a significant part of world agribusiness. Over the years, much of the emphasis of industrial research and development in the feed industry has been placed on the development of feed products that can improve the nutritional and physiological status of commercially bred and raised animals. Of course, such products must be made commercially available in a form that is both useful and convenient to those raising the animals. This is, of course, particularly true in the beef and dairy industries.

In the past, there have been several developments in the field. U.S. Pat. No. 4,016,296 (DeSantis) and U.S. Pat. No. 4,749,578 (Benton and Patrick), disclose chemically hardened molasses-based feed blocks or tubs for ruminants. These blocks are molasses-based, but may also include minerals, vitamins, protein and fat. Fat sources may include animal fats and/or vegetable fats such as acidulated soapstock. Such feed blocks are convenient for use in dairy and beef cattle applications and can provide nutrients, vitamins, minerals, and other dietary requirements.

Alternative feed supplements and/or blocks were described in U.S. Pat. No. 5,260,089 (Thornberg), in which corn condensed distillers solubles and distillers dried grains were used in the formulation of the supplements. These supplements were described as not utilizing molasses or urea in their formulation.

In providing feed supplementation, such products are formulated so that certain nutrient levels, including protein and fat contents, are achieved. However, the supplement forms described in the patents discussed above do not allow for production of supplements in useful forms having a higher fat content (a fat content over 10%). The patents discussed above disclose supplement products with fat levels in the range of from approximately 0.5% to about 10% maximum (by weight).

### SUMMARY OF THE INVENTION

Therefore, it is an object of the present invention to provide animal feed supplement tubs that contain higher levels of fat. The present invention relates to a tub containing greater than 10% fat, with preferred embodiments containing from about 11% to about 30% fat. More preferred embodiments contain from about 15% to about 25% fat, even more preferred embodiments contain from about 16% to about 20% fat.

In addition, the present invention also relates to the method of making supplement feed blocks or tubs with increased levels of fat. The method involves weighing the dry ingredients and discharging them into a suitable mixing device. Included in the dry ingredients are High Fat Product (HFP™), commercially available from Archer Daniels Midland Company, Decatur, Ill., and soy flour. Inclusion of these ingredients minimizes the addition of liquid fat and allows the mixture to remain flowable through the manufacturing process. Acidulated soapstock is added during mixing, followed by the addition of molasses and/or other liquid byproducts available to the feed industry. Examples of such liquid ingredients include, but are not limited to, condensed distiller solubles, soy molasses, concentrated whey, corn steep liquor, or fermentation byproduct liquids. Mixing is continued for a suitable time to intimately mix the liquid ingredients with the dry to form a moist, cohesive mixture. This mixture is then de-lumped, weighed and discharged into a tub container prior to pressing to form a dense mass that further solidifies to yield a product with acceptable consumption rates when fed.

The present invention also relates to a method for providing a high fat supplement to an animal by providing to the animal, as part of its regular dietary regimen, free-choice access to high energy, high fat content animal feed tub of the invention. Those of skill in the arts relating to raising and/or breeding of animals for commercial purposes, and particularly in the commercial livestock industries, will appreciate the utility of the animal feed tubs of the invention in providing a high fat supplement useful in such dietary programs.

### DETAILED DESCRIPTION OF THE INVENTION

The present invention takes advantage of the surprising and unexpected properties contributed to animal feed tub manufacture by two ingredients: (i) a low moisture, high fat ingredient, such as that available as High Fat Product (18% fat) from Archer-Daniels-Midland Company; and (ii) soy flour. Use of these two components in combination with acidulated soapstock in the animal feed supplement allows for markedly higher levels of fat to be included in the tub or block than have been previously achieved. Feed tubs of the present invention contain from about 11% to about 30%, and more preferably from about 15% to about 25%, and even more preferably from about 16% to about 20% fat (by weight), and are achieved using the method of the invention, through the inclusion of a low moisture, high fat product and soy flour.

The basic components of the tub, and used in the process for making the tub, of the present invention are a high fat ingredient, acidulated soapstock, soy flour, a reactive metal oxide, one or more liquid feed ingredient(s), and other proteins, minerals and vitamins as needed to achieve the desired nutritional profile in the product. The high fat ingredient is preferably ADM's High Fat Product, although other fat containing ingredients such as whole cottonseed or soybeans may be used. An alkaline earth metal oxide is added to create a chemical reaction between the free fatty acids in the acidulated soapstock and the added liquid ingredient. This chemical reaction causes the mixture to harden after pressing to help achieve a desired daily intake level for the product when fed free-choice. Highly reactive magnesium oxide is the preferred metal oxide, although other metal oxides such as calcium oxide may be used. The liquid feed ingredient may be one or more of the liquid ingredients typically available to the feed industry. Examples of such liquid ingredients include, but are not limited to, cane or beet molasses, condensed distiller solubles, soy molasses, concentrated whey, corn steep liquor, or fermentation byproduct liquids. The preferred combination of liquids is cane molasses and condensed distillers solubles. The proteins, minerals, and vitamins may be any of those typically available and commonly used in the animal feed industry.

A general protocol for production of a tub of the present invention is as follows: the dry ingredients are weighed and mixed. To these mixed dry ingredients are added acidulated soapstock and liquid feed ingredient(s), with continued mixing. The acidulated soapstock is heated to 140° to 160° F. to improve the penetration of the soapstock into the dry ingredients of the mix. If lumps or clumps form, the mixture can next be passed through a beater to break up any large chunks. This mixture is then weighed out into a tub container, the surface is leveled, and the contents of the tub are pressed to the desired density. The tubs are then cured, and are then ready for shipment.

The dry ingredients used in the process can generally be tailored to the needs of the market. The dry ingredients may include, for example, vitamins, minerals, grains, salts, and the like, in various relative amounts. For example, and not by way of limitation, salt, calcium sulfate, fine limestone, distillers dried grains, wheat midds, soybean meal, cottonseed meal, urea, biuret, corn gluten feed, soy hulls, ground corn, other grain byproducts, dry vitamins, and other dry ingredients may be included in various formulations. The dry ingredients will most preferably include soy flour, such as unclassified soy flour, which has been found to improve the flowability of the mixture through the handling system to the final tub container.

Acidulated soapstock is a recognized component of animal feed tubs such as those of the present invention. However, in the present invention, the amount of acidulated soapstock used can be minimized, thereby improving the flowability of the mixture prior to final formation of the tub. This minimization of the amount of acidulated soapstock included is achieved through the use of a low moisture high fat ingredient, for example, the product marketed by Archer-Daniels-Midland Company as High Fat Product or HFP™. This product is a blend of corn and soybean co-products from the vegetable oil extraction and refining processes, and a unique feature of HFP™ is that nearly one-half of the lipid content is rendered ruminally inert. In addition, the vegetable protein contained in HFP™ is nearly one-half rumen bypass. HFP™ also provides a source of degradable fiber. The ADM High Fat Product contains 18% crude fat, 17% crude protein, 4% starch, and 18% crude fiber, and has a bypass fat value of 48.4% and a bypass protein value of 49.5%.

As is the case with acidulated soapstock, molasses is also an art-recognized component of animal feed tubs. The inclusion of molasses in the mixture helps to reduce the generation of ammonia from the exposure of any urea included in the formulation of a tub to the various liquids included. Molasses will also benefit the palatability of the final tub product.

The present inventors have determined that, in preferred embodiments of the process of making the tubs of the present invention, addition of the acidulated soapstock before the liquid feed ingredient(s) yields a more flowable mixture. Improved flowability means that the mixture is less likely to hang up or clog in the handling system from the mixer to the final container. The acidulated soapstock is heated to 140° to 160° F. prior to addition to the dry ingredients, which are at ambient temperature. Molasses and condensed distillers solubles are added after the acidulated soapstock during the mixing process. The highly reactive magnesium oxide is preferably added in the dry mix, but may be added after the liquids have been added. During the mixing process, an exothermic reaction takes place between the highly reactive magnesium oxide, acidulated soapstock and moisture in the other liquid ingredients. This reaction results in an increase in the temperature of the mixture during the mixing process of from 10° to 300 F.

While condensed distillers solubles is a preferred ingredient, other liquids can be used in the practice of the invention, including for example, corn steep liquor, soy solubles, or other fermentation byproduct liquids.

In the final step, the product is hardened using the art-recognized technique of driving an exothermic reaction using a highly reactive metal oxide, such as highly reactive magnesium oxide, and water. The hardening process is further facilitated by pressing the material into the tub container, and then curing the tub prior to shipping. Typically, such tubs are pressed to a density of from about 82 to 87 lbs./ft³, although those of skill in the art will recognize that the final density of the formed product can vary. The time period and conditions for curing are also variable, and are not critical to the invention; for example, the tubs of the invention may be cured at ambient temperature for from 24 hours to 72 hours, or at elevated temperatures for less time.

The present invention provides a means for incorporating higher levels of fat into an animal feed tub, so as to provide a higher level energy source to the animals consuming the tub supplement. In the Example set forth below, the formulation provides a tub having 16% fat. However, higher fat levels, up to from about 25% to about 30% fat, can be formulated. As those of skill in the art will recognize, such increases in final fat content would require some optimization of process parameters and, of course, formula manipulation, but given the present disclosure, such manipulations would not require undue experimentation.

Having generally described the present invention, and how to make and use it, the invention is now further and more particularly described by reference to particular embodiments in the following Examples. The Examples are provided for purposes of illustration and not by way of limitation.

### EXAMPLE 1

This Example describes the production of a high energy 18/16 (18% protein/16% fat) tub. The formula for the specific tub of this Example was as follows:

TABLE 1

| Ingredient Name | Inclusion Level, % |
|---|---|
| Minerals | 4.90 |
| Blackstrap molasses | 5.00 |
| Salt | 6.13 |
| Distillers dried grains | 9.50 |
| Condensed distillers solubles | 6.00 |
| Highly reactive magnesium oxide | 5.00 |
| Acidulated soapstock | 10.90 |
| Trace minerals, vitamins | 0.31 |
| Wheat midds | 16.00 |
| Urea 287 | 1.26 |
| High fat product | 25.00 |
| Unclassified soy flour | 10.00 |
| | 100.00 |

The production process for the Hi-Energy 18/16 tub is described in the steps outlined below—

Weighup—

The dry ingredients in the formula were weighed prior to being conveyed to the mixer.

Mixing—

Dry ingredients were discharged into the mixer; acidulated soapstock at 140° to 160° F was added, followed immediately by the molasses and the condensed distillers solubles; mixing continued for 6 minutes after the completion of the liquid addition.

Weighing—

The final mixture was placed in a loss-in-weight feeder and the correct amount was discharged to the tub container prior to pressing.

Leveling—

The surface of the material in the tub was leveled to yield a more uniform density, and therefore hardness, of the material over its surface after pressing.

Pressing—

The loose material in the tub was pressed to consolidate the material to a density of 82 to 87 lbs./ft³. After pressing, the tubs were cured under ambient warehouse conditions, and were ready for shipment in 72 hours.

### EXAMPLE 2

This Example describes the production of a high energy 20/25 (20% protein/25% fat) tub. The formula for the specific tub of this Example was as follows:

TABLE 2

| Ingredient Name | Inclusion Level, % |
|---|---|
| Minerals | 5.00 |
| Blackstrap molasses | 3.50 |
| Salt | 6.50 |
| Distillers dried grains | 0.50 |
| Condensed distillers solubles | 3.50 |
| Highly reactive magnesium oxide | 6.68 |
| Acidulated soapstock | 20.00 |
| Trace minerals, vitamins | 0.32 |
| High fat product | 25.00 |
| Unclassified soy flour | 29.00 |
| | 100.00 |

The production process for the Hi-Energy 20/25 tub is the same as the process described in Example 1.

Other objects, advantages, features and modifications of this invention will be apparent to those skilled in the art in view of the foregoing disclosure, and the invention is not limited except as set forth in the following claims.

What is claimed is:

1. A high fat animal feed tub comprising acidulated soapstock, a low moisture high fat ingredient, at least one liquid feed ingredient(s), a highly reactive metal oxide, and soy flour, such that the amount of fat in the final tub is from at least about 11% to about 30% by weight.

2. The high fat animal feed tub of claim 1, further comprising one or more of salts, vitamins, minerals, grains or grain byproducts, urea, and water, formulated so that the feed tub has a final fat content of from at least about 11% to about 30% by weight.

3. A high fat animal feed tub made by a process comprising the steps of:
(a) weighing the dry ingredients of the tub, the dry ingredients comprising soy flour, a highly reactive metal oxide, and a low moisture high fat product;
(b) mixing the dry ingredients with one or more selected liquid feed ingredients;
(c) weighing or measuring the mixture of step (b) into a tub container;
(d) pressing the mixture in the tub container to a predetermined density; and
(e) curing the final high fat animal feed tub.

4. A process for making a high fat animal feed tub, the process comprising the steps of:
(a) weighing the dry ingredients of the tub, the dry ingredients comprising soy flour, a highly reactive metal oxide, and a low moisture high fat product;
(b) mixing the dry ingredients with one or more selected liquid feed ingredients;
(c) weighing or measuring the mixture of step (b) into a tub container;
(d) pressing the mixture in the tub container to a predetermined density; and
(e) curing the final high fat animal feed tub.

5. A high fat animal feed tub formulated to the specifications set forth in Example 1 or Example 2.

6. A method for providing a high fat supplement to an animal, the method comprising providing the animal, by feeding free-choice, with a high fat animal feed tub of claim 1.
